(19) United States
(12) Patent Application Publication
(10) Pub. No.: US 2014/0048424 A1
(43) Pub. Date: Feb. 20, 2014

(54) METHODS AND DEVICES FOR THE DETECTION OF BIOFILMS

(71) Applicant: Tingyue Gu, Athens, OH (US)

(72) Inventor: Tingyue Gu, Athens, OH (US)

(73) Assignee: OHIO UNIVERSITY, Athens, OH (US)

(21) Appl. No.: 14/114,095

(22) PCT Filed: Apr. 27, 2012
(86) PCT No.: PCT/US2012/035681

§ 371 Date: Oct. 25, 2013

Related U.S. Application Data
(60) Provisional application No. 61/479,635, filed on Apr. 27, 2011.

(51) Int. Cl. G01N 17/02

(52) U.S. Cl. CPC G01N 17/02
USPC 205/776.5; 204/404

(57) ABSTRACT

Methods and devices for the detection of corrosive biofilms and microbiologically influenced (MIC) corrosion rates are based upon the electrogenicity of the biofilms. The device may comprise a passive sensor having at least one first electrode, at least one second electrode, and an external circuit for electrically connecting the first electrode to the second electrode. At least one of the first electrode and the second electrode is capable of being at least partially coated by a biofilm. A sustainable electrical characteristic, such as voltage and current, generated when the first electrode and the second electrode are electrically connected and exposed to at least one medium indicates that the biofilm partially coating at least one of the first electrode and the second electrode is electrogenic, and thus corrosive. Special electrode and sensor designs are needed for the implementation of online and offline biofilm sensors.

### CROSS-REFERENCE TO RELATED APPLICATIONS

This application claims priority to and any other benefit of U.S. Provisional Patent Application Ser. No. 61/479,635, filed on Apr. 27, 2011, the content of which is hereby incorporated by reference.

### TECHNICAL FIELD

The present disclosure relates to the field of biofilm detection, and more particularly to methods and devices for the detection of biofilms that are electrogenic, and thus corrosive. The present disclosure also relates to the measurement of how corrosive a biofilm can be against a metal such as carbon steel and stainless steel.

### BACKGROUND

Microbiologically influenced corrosion (MIC), also known as biocorrosion, causes billions of dollars in damage each year to various industries, including food processing, manufacturing, chemical processing, water utilities, and particularly, the oil and gas industry, just to name a few. Typically, MIC is a long-term process ranging from months to years. Mitigating MIC is costly, not only in terms of the cost of chemical treatments, but also in terms of lost production due to maintenance shutdowns. MIC is also known to adversely affect aging infrastructure, including piers, bridges, factories, shipyards, water towers, heat exchangers, fluid transfer pipes, and water treatment facilities. According to some sources, MIC accounts for approximately 20% of all corrosion of metals and building materials. MIC was the primary suspect in the 2006 Prudhoe Bay, Ak. pipeline leak (¼″ pinhole). MIC is becoming more problematic because infrastructures are aging and enhanced oil recovery is practiced more often than ever.

Due to depleting reserves, and high oil and gas prices, previously unproductive or non-cost effective reservoirs remain in production by utilizing an enhanced oil recovery process known as flooding. The flooding process involves the use of water or carbon dioxide (CO₂) to increase well pressure to push out residual oil from the reservoir. Most often, seawater, which introduces bacteria and nutrients to the system, is used in the flooding process. Seawater contains nutrients for microbial growth and bacteria such as sulfate reducing bacteria (SRB). In addition, bacteria from geological times may already be present in the reservoir. Microbial activities in reservoirs frequently cause souring due to sulfate reduction to form H₂S gas. Oil pipelines are prone to MIC because microbes, water and nutrients are all present. Moreover, gas pipelines are not immune to MIC because a trace amount of moisture is unavoidable due to condensation.

In contrast to general corrosion, MIC tends to be very localized. Biofilms, the major cause of MIC, are generally composed of microbial cells and their extracellular products (extracellular polymers), which confer to them a very porous structure, in agreement with the amount of water contained (>95% w/w). The distribution of microorganisms in a biofilm is not uniform. In multi-species biofilm consortia, highly complex structures containing voids, connecting channels between these voids, and microbial clusters or layers have been found. When a biofilm forms on a substrate, it may create a nodule and a pit may form beneath the nodule. The nodule may have an outer portion comprising aerobic bacteria that consumes oxygen, and an inner portion that experiences reduced oxygen levels that allow anaerobic bacteria to thrive. Once established, MIC is extremely difficult to eliminate and may develop into a chronic maintenance and operating problem for many years. The failure to totally remove MIC from crevices and the furthermost branches and dead legs of a piping system will generally result in reinfection by the same microorganisms within a short period of time after biocide and/or pigging treatments.

In many cases, the primary concern with respect to MIC is anaerobic corrosion as opposed to aerobic corrosion because anaerobic biofilms live beneath aerobic biofilms. Anaerobic corrosion is due to dissolution of iron from the iron oxidation reaction below:

Fe→Fe²⁺+2e⁻ (iron oxidation reaction) (1)

where Fe²⁺ dissolves in the bulk fluid. The Fe²⁺ may also react with other chemical species and precipitate. When sulfate and SRB are present, the SRB produce sulfide that can form iron sulfide (FeS), which has limited solubility in water. After reaching super saturation, FeS will precipitate, producing a black ink color. Generally, FeS precipitation along with the rotten egg-like smell of H₂S indicates the presence of SRB activity.

The electrons released by the iron oxidation reaction must be removed to drive Reaction 1 forward. Microbes in a biofilm on an iron-containing substrate, such as a carbon steel surface, may utilize the electrons for reduction reactions such as sulfate reduction by SRB and nitrate reduction by nitrate reducing bacteria (NRB), as shown below:

SO₄²⁻+9H⁺+8e⁻→HS⁻+4H₂O (sulfate reduction) (2)

2NO₃⁻+10e⁻+12H⁺→N₂+6H₂O (nitrate reduction) (3)

Reactions 2 and 3 do not move forward without biocatalysis by a biofilm. Microbes such as SRB typically require organic carbons for growth. Oxidation of the organic carbon provides electrons and carbon building blocks for organic synthesis. The electrons are used for reduction reactions as seen in Reactions 2 and 3. The redox reaction produces energy for cellular metabolism and maintenance, which forms the basics of anaerobic respiration.

Volatile fatty acids such as acetate and lactate are often used by SRB as a source of organic carbon. Acetate is usually more readily available than lactate in pipeline systems, but lactate is often used in laboratory tests because lactate is a better nutrient. As an example, the lactate oxidation reaction is shown below.

CH₃CHOHCOO⁻+H₂O→CH₃COO⁻+CO₂+4H⁺+4e⁻ (lactate oxidation) (4)

The organic carbon oxidation reaction (Reaction 4) also requires biocatalysis by microbes such as SRB. When lactate oxidation is coupled with Reaction 2 or 3, the redox reaction produces energy. Organic carbon oxidation and oxidant (e.g., sulfate, nitrate, and nitrite) reduction occur in the cell's cytoplasm as shown in FIG. 1.

If Reactions 2 and 4 both occur in the cytoplasm, no external electrons are involved. Thus, direct electrochemical corrosion due to utilization of the electrons released by iron oxidation cannot occur. However, when a SRB biofilm forms on an iron substrate as shown in FIG. 2, the sessile cells (i.e., the biofilm cells directly attached to the substrate) may be starved of organic carbon because the biofilm acts as a mass transfer barrier for organic carbon transport from the bulk fluid phase to the iron substrate. Even if cell proliferation is not occurring, microbes require maintenance energy for survival. To survive in the organic carbon starved environment, the sessile cells may utilize the electrons released from the iron oxidation reaction—to accomplish sulfate reduction in the cytoplasm. This redox reaction is equally as energetic as lactate oxidation coupled with sulfate reduction because lactate and iron have very similar standard reduction potentials (at pH 7), −430 mV and −447 mV, respectively. This represents the basic mechanism by which electrochemical corrosion occurs as a result of the presence of a biofilm that lives on anaerobic respiration. Fermentative bacteria do not use external electron acceptors such as sulfate and nitrate. They produce their own electron acceptors to achieve electro-neutrality in metabolism. A typical example is acid producing bacteria (APB) or acid producing fungi that produce organic acids such as acetic acid. APB secrete organic acids that can corrode metals without biocatalysis from the cells. Thus, there is no need for the cells to be electrogenic for MIC to occur. In reality, however, microbes live in a synergistic biofilm consortia. Organic acids secreted by fermentative microbes are actually organic carbons favored by SRB. By detecting the SRB in a biofilm consortium using this invention, APB can also be indirectly detected because an electrogenic biofilm sample, once detected, may be further analyzed using microbiological and molecular biology assays to find out what microbial species are in the biofilm.

Unlike lactate, insoluble elemental iron cannot directly enter the cytoplasm to donate electrons. Therefore, the iron oxidation reaction (Reaction 1) occurs outside of the microbial cells. However, the electrons released by the iron oxidation reaction must enter the cell's cytoplasm to be utilized for sulfate reduction, as shown in FIG. 2. Fundamentally, electron transfer into cells is problematic as cells are not good electron conductors and electrons cannot “swim” in the fluid. Moreover, electrons cannot easily cross into a cell's cytoplasm from outside of the cell, and this is a bottleneck step in MIC.

There are two primary methods for electron transfer between a fluid and the cytoplasm of a cell: (a) direct electron transfer (DET); and (b) mediated electron transfer (MET). DET relies on special proteins and other molecules in the cell wall and inside the cell to pass electrons. For DET, direct contact with the substrate (e.g., iron substrate) is needed unless cells form pili to bridge the cell and the substrate. Typically a monolayer of sessile cells directly on a substrate (e.g., an iron substrate) is capable of accepting electrons from iron oxidation. However, it is likely that cells that form pili may link several layers of sessile cells with the iron substrate, thus causing more severe MIC. On the other hand, MET relies on electron mediators that are redox active electron carriers to shuttle electrons between the substrate and the cells. Mediators are soluble molecules capable of catching and releasing electrons. Mediator diffusion in the fluid results in the transfer of electrons and these carriers may also cross cell walls and membranes. When mediators or electron carriers are present, more than one layer of cells may contribute to the corrosion process. Apart from externally added mediators, some microbial cells are capable of secreting mediators to facilitate electron transfer. As a result, more electrons may be harvested from the iron oxidation reaction, resulting in more severe MIC due to an increase in the number of available electrons utilized by cells for reduction of an oxidant, such as sulfate, in the cytoplasm.

The above discussion indicates that certain microbial cells have the ability to transfer and accept electrons, which is also known as electrogenicity. To cause direct electrochemical MIC, the sessile biofilm cells must be electrogenic. Thus, the corrosiveness of a biofilm is directly related to the electrogenicity of the biofilm. In some cases, non-electrogenic biofilm cells may also be considered electrogenic biofilm cells if they are capable of electron transfer between a metal substrate and cells with the help of electron mediators, such as mediators secreted by other microbes in the same biofilm community or mediators that are externally added. The ability to detect corrosive biofilms in places such as the inner surface of pipe walls is a long-standing problem. Currently, there are no reliable means for detecting corrosive biofilms due to a lack of understanding of exactly how biofilms attack metals.

Some current methods and devices for biofilm detection use the linear polarization resistance (LPR) sweep technology. The assumption behind this technology is that the presence of a biofilm will correlate to a LPR response. Theoretically, the assumption behind this technology is inconsistent with basic biofilm bio-electrochemistry. It has been determined that biofilms are typically poor electron conductors, and in most cases, biofilm behavior has been found to be inductive, rather than resistive in nature. The LPR technology is intended for resistive films rather than inductive films. As a consequence, methods and devices utilizing LPR technology are likely to provide false positives. For example, LPR technology cannot distinguish between the presence of a mineral film, which is sometimes resistive, and a biofilm. Moreover, imposing an external voltage across a biofilm (e.g., as required by LPR) may interfere with microbial metabolism. When an external voltage is applied, the biofilm may shut down its native corrosion process because it can use the “free” electrons supplied by the externally applied voltage without consuming resources needed to get the external electrons. In fact, during the investigation of impressed current cathodic protection (ICCP) against MIC, researchers found that an externally imposed voltage actually attracted SRB biofilm growth.

Furthermore, current sensors cannot differentiate between a corrosive biofilm (i.e., an electrogenic biofilm) and a non-corrosive biofilm (i.e., a non-electrogenic biofilm), even if the sensor can detect the presence of a biofilm. Another major problem associated with LPR technology is the cost derived from the requirement for an expensive potentiostat and the appropriate software. The LPR sweep technology requires a potentiostat that may be programmed to gradually increase the externally imposed voltage across a system containing a biofilm and measures the current density and calculates the polarization resistance. The hardware and software required to run such LPR sensor systems currently costs up to several thousands of dollars.

Another reported method relies on the presence of iron sulfide (FeS) to detect biofilms. However, this is not reliable in most cases because abiotic FeS is typically present in most systems. Furthermore, when MIC is caused by other microbes such as methanogens or NRB, the presence of FeS is irrelevant for biofilm detection. Moreover, other methods for the detection of biofilms and MIC rely upon the nutritional and microbiological environment from which a sample is collected. Often times, the sample merely contains planktonic microbes, and not the biofilm microbes known to cause MIC pitting.

Thus, there remains a need in the art for a method and device that can accurately detect the presence of a corrosive biofilm while doing so in a passive manner so as to not interfere with the biofilm's intrinsic corrosion processes. There is also a need to measure how corrosive a biofilm is against a certain metal substrate. In addition, there remains a need in the art for a method and device for accurately detecting the presence of a corrosive biofilm that is not cost prohibitive.

### BRIEF SUMMARY

The present disclosure relates to methods and devices for passively detecting an electrogenic, and thus corrosive biofilm. In an exemplary embodiment, a method for passively detecting a corrosive biofilm includes the steps of: a) exposing a first electrode to at least one medium containing microbes capable of forming a biofilm; b) allowing a biofilm to form on at least a portion of the first electrode; c) electrically connecting the first electrode having the biofilm formed on a portion thereof to a second electrode; and d) measuring an electrical characteristic generated by the electrically connected first electrode and second electrode to determine whether the biofilm is electrogenic.

In another embodiment, a sensor for passively detecting a corrosive biofilm is provided. The sensor may include at least one first electrode, at least one second electrode, and an external circuit for electrically connecting the first electrode to the second electrode. At least one of the first electrode and the second electrode is capable of being at least partially coated by a biofilm. A sustainable electrical characteristic, such as a voltage or a current, generated when the first electrode and the second electrode are electrically connected and exposed to at least one medium indicates that the biofilm partially coating at least one of the first electrode and the second electrode is electrogenic, and thus corrosive.

Additional features and advantages will be set forth in part in the description that follows, and in part will be obvious from the description, or may be learned by practice of the disclosed embodiments. The objects and advantages of the disclosed embodiments will be realized and attained by means of the elements and combinations particularly pointed out in any appended claims. It is to be understood that both the foregoing general description and the following detailed description are exemplary and explanatory only and are not restrictive of the disclosed embodiments, as may be claimed.

### BRIEF DESCRIPTION OF THE DRAWINGS

The accompanying drawings, which are incorporated in and constitute a part of this specification, illustrate exemplary embodiments of the disclosed methods and devices, and together with the description, serve to explain principles of the methods and devices disclosed herein.

FIG. 1 is a representation of anaerobic respiration in the cytoplasm of a sulfate reducing bacterium utilizing acetate and sulfate.

FIG. 2 shows how electrons from iron oxidation are used for sulfate reduction inside the cytoplasm of a sulfate reducing bacterium, thus causing corrosion.

FIG. 3 shows an embodiment of a sensor for passively detecting a corrosive biofilm formed on a cathode electrode using a voltmeter/ammeter.

FIG. 4 shows an embodiment of a sensor for passively detecting a corrosive biofilm formed on an anode electrode.

FIG. 5 shows a general schematic of an embodiment of an anodic sensor for passively detecting a corrosive biofilm inside a pipeline.

FIG. 6 shows a general schematic of an embodiment of a cathodic sensor for passively detecting a corrosive biofilm inside a pipeline.

FIG. 7 shows an embodiment of a sensor for passively detecting a corrosive biofilm using a silver/silver sulfide anode electrode without a proton exchange membrane.

FIG. 8 shows an embodiment of a sensor for passively detecting a corrosive biofilm using a tantalum/tantalum pentoxide anode electrode.

FIG. 9A shows an embodiment of an online cathodic sensor for passively detecting a corrosive biofilm.

FIG. 9B shows an embodiment of an online cathodic sensor for passively detecting a corrosive biofilm.

FIG. 10 shows an embodiment of a sensor for passively detecting a corrosive biofilm on a surface of a structure.

FIG. 11 shows an embodiment of a drop-in sensor module for passively detecting a corrosive biofilm.

FIG. 12 shows an embodiment of a sensor array for passively detecting whether multiple liquid samples can form electrogenic biofilms.

FIG. 13 shows an embodiment of a microbiological fuel cell setup utilized to form an electrogenic biofilm on an electrode.

FIG. 14 shows an embodiment of a sensor for passively detecting a corrosive biofilm.

FIG. 15 shows a plot of the voltage output responses versus time of an embodiment of a sensor having a cathode electrode partially coated by a live biofilm, a cathode electrode partially coated by a biofilm that was killed, and a cathode electrode without a biofilm.

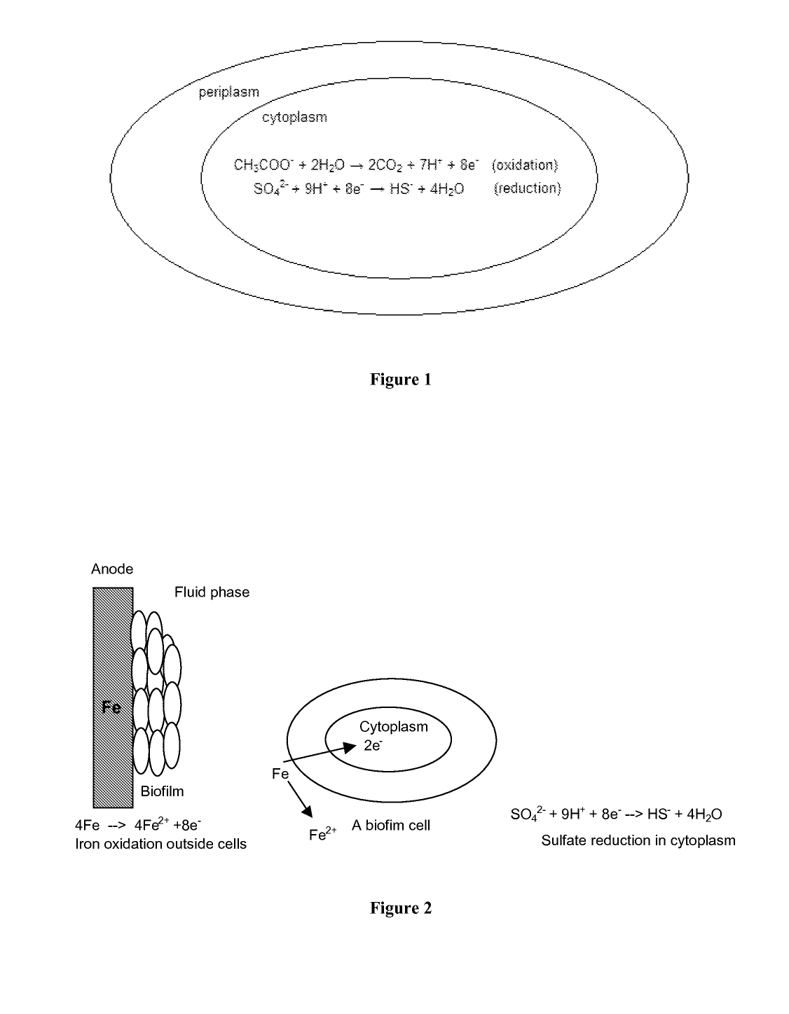

### DETAILED DESCRIPTION

Unless otherwise defined, all technical and scientific terms used herein have the same meaning as commonly understood by one of ordinary skill in the art to which the invention belongs. The terminology used in the description of the invention herein is for describing particular embodiments only and is not intended to be limiting of the invention. The present invention may be embodied in different forms and should not be construed as limited to the embodiments set forth herein. Rather, these embodiments are provided so that this disclosure will be thorough and complete, and will fully convey the scope of the invention to those skilled in the art.

As used in the description of the invention and the appended claims, the singular forms “a,” “an,” and “the” are intended to include the plural forms as well, unless the context clearly indicates otherwise.

Unless otherwise indicated (e.g., by the use of the term “precisely”), all numbers expressing quantities of ingredients, reaction conditions, and so forth as used in the specification and claims are to be understood as being modified in all instances by the term “about.” Accordingly, unless indicated to the contrary, the numerical parameters set forth in the following specification and attached claims are approximations that may vary depending upon the desired properties sought to be obtained in embodiments of the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the inventions are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

“Microbiologically influenced corrosion (MIC)” shall refer to processes in which any element of a system is structurally compromised due to the action of at least one member of a microbial population.

The expressions “microbial fuel cell (MFC),” “biofilm sensor,” and “biological fuel cell” shall mean any bio-electrochemical system that drives a current by mimicking microbial interactions found in nature. “MFC” may also be defined as any biological device that evaluates the non-nutritional, electrochemical environment in which a sample is located and/or contained.

“Partially coated,” shall mean that any portion of the surface of an electrode that is covered by a biofilm. In some embodiments the percentage of the coverage of the surface consists of 0.1, 0.25. 0.5, 0.75, 1, 5, 10, 15, 20, 25, 30, 35, 40, 45, 50, 55, 60, 65, 70, 75, 80, 85, 90, 95, and 100 percent.

The expression “biofilm” refers to an aggregate of microorganisms in which cells adhere to adjacent cells and/or to a surface. These adjacent cells are frequently embedded within a self-produced extracellular matrix of polymeric substances often composed of proteins and polysaccharides. Microbial cells in a biofilm are physiologically distinct from planktonic cells of the same organism, which, by contrast are single cells that may swim or float through a fluid.

The expression “aqueous solution,” when used to describe a composition, refers to a solution in which the solvent is water, including water containing salts, such as: magnesium sulfate (MgSO₄), sodium citrate, calcium sulfate (CaSO₄), ammonium chloride (NH₄Cl), dipotassium phosphate (K₂HPO₄), sodium lactate (NaC₃H₅O₃), and ammonium iron (II) sulfate Fe(NH₄)₂(SO₄)₂; water containing volatile fatty acids, salts of volatile fatty acids, alcohols, hexoses, and hydrogen; ocean or seawater; brackish water; sources of freshwater, including lakes, rivers, stream, bogs, ponds, marshes, runoff from the thawing of snow or ice; springs, groundwater, and aquifers; and precipitation.

The expression “oil,” when used to describe a material in a method, refers to any substance that is a liquid at ambient temperature and is hydrophobic but soluble in organic solvents, including but not limited to hexanes, benzene, toluene, chloroform, and diethyl ether. Classes of compounds included within the context of the above definition include vegetable oils, petrochemical oils (e.g., crude and refined petrochemical products), and volatile essential oils (i.e., aroma compounds from plants).

The expression “fuel,” when used to describe a material in a method, refers to any substance that stores energy, including fossil fuels, gasoline, mixtures of hydrocarbons, jet and rocket fuels, and biofuels.

The expressions “metal,” “metallic,” and “metal alloy,” when used to describe a substance in a method, refer to any elemental metal or alloy comprised of elemental metals (e.g., brass, bronze, and steel). Examples of metal and metal alloy products include but are not limited to pipes, infrastructure, beams, sheeting, prefabricated structures, underwater structures, retaining structures (e.g., water towers), military installations and structures, military equipment (e.g., submarines and ships), and munitions.

“Microbes” shall mean any and all microorganisms capable of colonizing and/or causing MIC, either directly or indirectly. Examples of microbes that generally colonize and cause damage to pipelines in the gas and oil industries are Proteus mirabilis, Erwinia dissolven, Lactobacillus plantarum, Streptococcus lactis, Actinobacillus succinogenes, Gluconobacter oxydans, Klebsiella pneumoniae, Shewanella oneidensis, Shewanella putrefaciens IR-1, Desulfuromonas acetoxidans, Geobacter metallireducens, Geobacter sulfurreducens, Rhodoferax ferrireducens, Aeromonas hydrophile, Desulfobulbus propionicus, Pichia anomala, Rhodopseudomonas palustris, Ochrobactrum anthropi, Acidiphilium sp., Thermincola sp., Geopsychrobacter electrodiphilus, Enterobacter and Citrobacter bacteria (e.g., E. dissolvens, E. ludwigii, C. farmeri and C. amalonaticus); Eubacterium and Clostridium bacteria (e.g., Clostridium butyricum, Clostridium algidixylanolyticum, Anaeorfilum pentosovorans, Bacteroides sp., Acinobacter sp., Propionibacterium sp.); sulfate reducing bacteria including but not limited to Desulfovibrionales (e.g., Desulfovibrio desulfuricans, Desulfovibrio vulgaris, Desulfovibrio aminophilus); nitrate reducing bacteria; nitrite reducing bacteria; methanogens; Desulfobacterales, and Syntrophobacterales; thiosulfate reducing anaerobes (e.g., Geotoga aestuarianis, Halanaerobium congolense, Sulfurospirillum sp.); tetracholoroethene degrading anaerobes (e.g., Sporomusa ovata); triethanolamine degrading bacteria (e.g., Acetobacterium sp.); denitrifiers (e.g., Acidovorax sp., Pseudomonas sp.); xylan degrading bacteria; Nitrospirae; Halomonas spp.; Idiomarina spp.; Marinobacter aquaeolei; Thalassospira sp.; Silicibacter sp.; Chromohalobacter sp.; Bacilli (e.g., Bacillus spp. Exiguobacterium spp.); Comamonas denitrificans; Methanobacteriales; Methanomicrobiales; Methanosarcinales. Examples of microbes that generally colonize and cause damage to pipelines in other industries are: Staphylococcus aureus, Methicillin-resistant Staphylococcus aureus (“MRSA”), Escherichia coli, Enterococcus fecalis, Pseudomonas aeruginosa, Aspergillus, Candida, Clostridium difficile, Staphylococcus epidermidis, and Acinobacter sp.

The expression “electrochemical,” when used to describe a property, refers to the study of chemical or biochemical reactions which take place in solution at the interface of an electron conductor and an ionic conductor, and which involves electron transfer between the electrode and the electrolyte species in solution.

The terms “electrogenic” or “electrogenicity” shall herein refer to the property of a living organism to produce electrical activity or an electric response related to the transfer or utilization of electrons in biological processes.

The term “electrical characteristic,” as used herein, refers to an electrical quantity, such as voltage, electric current, electrical resistance, open circuit voltage, etc.

The term “medium,” as used herein, refers to a fluid to which an electrode of the present invention is exposed. The fluid may be a liquid and/or a gas, and includes, but is not limited to, MgSO₄ solution, NaCl solution, buffer solutions such as phosphate buffered saline (PBS), air, oxygen, hydrogen, water, and the previously defined terms “aqueous solution,” “oil,” and “fuel.” The medium must contain ionic species for electrical conduction.

The terms “passive” or “passively,” as used herein, refers to the absence of an externally applied voltage or electric field.

The term “sustainable,” as used herein to describe an electrical characteristic, means that the electrical characteristic being measured does not dissipate in less than about thirty minutes.

Disclosed herein are methods and devices for passively detecting corrosive biofilms based upon the electrogenicity of the biofilm. As previously noted, direct electrochemical MIC process requires an electrogenic biofilm on a metal surface. In an exemplary embodiment, an electrogenic biofilm is capable of transporting electrons from a metal oxidation reaction (e.g., iron oxidation, Reaction 1) to the cytoplasm of biofilm cells where a reduction reaction utilizes the electrons. The biofilm's electron “uptake” drives Reaction 1 forward, causing iron dissolution. The loss of iron is stoichiometrically related to the loss of electrons from iron oxidation. For every two electrons lost, one iron (Fe) atom becomes soluble ferrous ion (Fe²⁺). Thus, directly measuring the number of electrons transferred between an iron surface and a biofilm may indicate biofilm corrosiveness, and the presence or rate of MIC. However, no sensor has been disclosed that can be placed between a metal surface and a biofilm for measuring electron transfer. Such a sensor is unlikely possible because it would interfere with the MIC process itself.

Disclosed herein are passive sensors that detect whether a biofilm is electrogenic, and thus corrosive. In an exemplary embodiment, the sensor includes at least one first electrode, at least one second electrode, and an external circuit for electrically connecting the first electrode to the second electrode. At least one of the first electrode and the second electrode is capable of being at least partially coated by a biofilm. A sustainable electrical characteristic generated when the first electrode and the second electrode are electrically connected and exposed to at least one medium indicates that the biofilm partially coating at least one of the first electrode and the second electrode is electrogenic, and thus corrosive.

In one embodiment, the sensor may be formed as a microbial fuel cell (MFC). In this embodiment, the first electrode may operate as an anode, while the second electrode may operate as a cathode. Alternatively, the first electrode may operate as a cathode, and the second electrode may operate as an anode. The sensor may include a chamber having a first electrode compartment and a second electrode compartment. A proton exchange membrane (PEM) may be utilized to separate the first electrode compartment and the second electrode compartment. The first electrode compartment includes the first electrode and a first medium, and the second electrode compartment includes the second electrode and a second medium. The sensor also includes an external circuit for electrically connecting the first electrode to the second electrode.

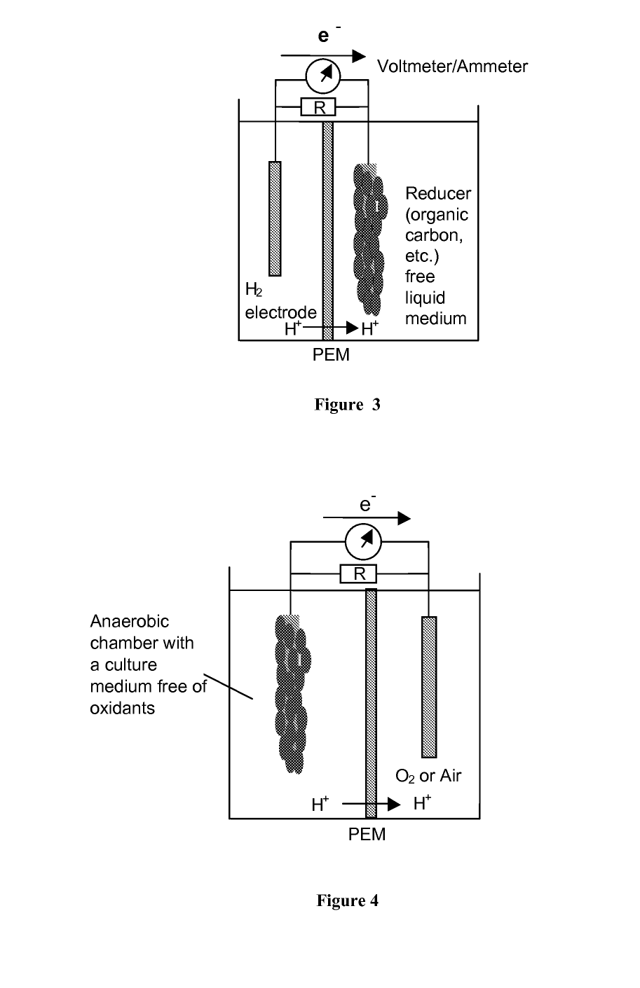

Referring now to FIG. 3, an exemplary embodiment of a biofilm sensor is shown. This particular embodiment is exemplary of a cathodic biofilm sensor. In this embodiment, the first electrode operates as the anode, and the second electrode is partially coated by a biofilm and operates as the cathode. As seen in FIG. 3, the chamber is divided by a proton exchange membrane (PEM) into a first electrode compartment (i.e., anode compartment) and a second electrode compartment (i.e., cathode compartment). The second electrode may comprise a metal (e.g., carbon steel, stainless steel, ferrous alloy, etc.) coupon partially coated by a biofilm and the second medium may comprise one or more oxidants including, but not limited to, sulfate, nitrate, nitrite, and carbon dioxide. Additionally, the second medium may be free of organic carbon and dissolved hydrogen. The first electrode compartment may be configured as an abiotic chemical anode such as a hydrogen (H₂) anode where the first medium comprises hydrogen in equilibrium with water (e.g., 1 bar of hydrogen in headspace in equilibrium with pH 7 liquid water) that provides a standard potential of −414 mV. The first electrode may comprise a catalytic electrode material such as a platinum, platinized metal, or other effective catalytic electrodes known to those of ordinary skill in the art. The following two reactions occur in the first electrode compartment (i.e., anode compartment) and the second electrode compartment (i.e., cathode compartment), respectively using an SRB biofilm as an example:

H₂→2H⁺+2e⁻ Anodic reaction (5)

SO₄²⁻+9H⁺+8e⁻→HS⁻+4H₂O Cathodic reaction (6)

The oxidation and reduction reactions are split into two separate half cells so that the electron flow from the anodic chamber to the cathodic chamber can be measured.

The coupling of Reactions 5 and 6 releases energy. In some embodiments, a sustainable electrical characteristic (e.g., voltage and current) may be generated, but only if the biofilm is capable of transferring electrons from the second electrode to the cytoplasm of the SRB for sulfate reduction. In some embodiments, the sensor is designed so that the limiting step is the electron transfer between the second electrode and the biofilm. To make this happen, electron transfer resistance between dissolved hydrogen (H₂) and the anode is minimized via a first electrode having a sufficiently large area. The internal resistance is also minimized by using a Nafion™ membrane with a sufficiently large surface area. In some embodiments, the sustainable electrical characteristic is detected by a voltmeter, a zero resistance ammeter (ZRA), a picoammeter, or a standard multimeter. Preferably, an ammeter utilized herein also has the ability to measure voltage. Both open circuit voltage and closed circuit voltage are useful electrical characteristics. In order to measure the closed circuit voltage, an external resistor (represented by “R” in FIG. 3) is needed. The resistance can be 1, 10, 100, or 1000 ohms depending on the internal resistance of the sensor. The detection of a sustainable electrical characteristic, such as voltage or current, indicates that the biofilm is electrogenic, and thus corrosive.

In some embodiments, the sensor shown in FIG. 3 is a passive sensor because no external voltage is imposed. Non-corrosive (i.e., non-electrogenic) biofilms are incapable of accepting electrons from the second electrode. Therefore, non-electrogenic biofilms fail to generate any sustainable electrical characteristic, such as voltage and current. In other embodiments, corrosive biofilms accept electrons from the second electrode and utilize the electrons for reduction reactions in the cytoplasm. The reduction reactions in the cytoplasm consume the electrons from hydrogen (H₂) oxidation in the first electrode compartment. This drives the electron flow from the first electrode to the second electrode through the external circuit. The generated electrical characteristic may be measured by an electrical measuring device such as a voltmeter/ammeter combo meter. In some embodiments, detection of a corrosive biofilm, and the type of corrosive biofilm (e.g., sulfate reducing bacteria, nitrate reducing, bacteria, methanogens, etc.), is associated with a measurable voltage, and the biofilm's aggressiveness may be reflected by the sustainable current. In some embodiments, calibration may be achieved by comparing the measured electrical characteristic to electrical characteristics associated with known corrosive biofilms to determine the type of corrosive biofilm present.

For example, a common corrosive biofilm such as Desulfovibrio desulfuricans may be tested to determine its electrical characteristics in laboratory or field pitting tests. Standardized pitting tests may be carried out in anaerobic vials with metal coupons. In some embodiments, coupons may be examined for surface pit size and shape, and total weight loss. In some instances, the deepest pit may be the most important measurement of biofilm aggressiveness or MIC pitting rate because MIC failure is often associated with the deepest pits. In some embodiments, the passive sensor as described above may be able to detect SRB, NRB, and methanogens. For more precise measurements of the electrical characteristic, the second medium in the second electrode compartment should be free of organic carbon or dissolved hydrogen that can be utilized by the biofilm, because localized oxidation of these compounds can be coupled with the reduction of an oxidant without the need for electrons donated from the second electrode which comes from the first electrode via the external circuit. To mimic the real fluid condition in a pipeline, the actual fluid with organic carbon or dissolved H₂ or an artificial solution simulating the local pipeline fluid can be used as the second medium in the second electrode compartment. This fluid may produce lower measured electrical characteristics (i.e., voltage and current) compared to a medium without organic carbon (or dissolved H₂). However, the measured electrical characteristics more realistically reflect the actual MIC ability of the biofilm in that fluid environment.

In some embodiments, the second electrode (i.e., cathode) of the sensor shown in FIG. 3 may comprise a non-reactive, conductive material such as a graphite. The inert material is utilized to avoid potentially inaccurate readings of measured electrical characteristics. For example, an oxidation reaction on the surface of an iron-based second electrode can supply electrons that replace the need for electrons from the first electrode. This means that the reduction reaction on the second electrode may use electrons released by the iron oxidation reaction because the Fe²⁺/Fe standard reduction potential is more negative than the hydrogen reference electrode potential at pH 7. Thus, if the biofilm utilizes electrons from the iron oxidation reaction, the sensor may not detect a sustainable electrical characteristic, such as the voltage or current.

Referring now to FIG. 4, another exemplary embodiment of a sensor formed as a microbial fuel cell (MFC) is shown. This particular embodiment is exemplary of an anodic biofilm sensor. In this embodiment, the first electrode is partially coated by a biofilm and operates as the anode, and the second electrode operates as the cathode. As seen in FIG. 4, the chamber is divided into a first electrode compartment (i.e., anode compartment) and a second electrode compartment (i.e., cathode compartment) by a proton exchange membrane (PEM). The first electrode may comprise a metal (e.g., carbon steel, stainless steel, etc.) coupon partially coated by a biofilm and the first medium may comprise an organic carbon such as various volatile fatty acids (e.g., acetate, lactate, etc.) or hydrogen to serve as electron donors. The first electrode compartment may be maintained in an anaerobic condition, and the first medium may be free of oxidants such as sulfate, nitrate, and nitrite, just to name a few. The second electrode compartment may be configured as an oxygen or air cathode, and the second electrode may be selected from the group consisting of a graphite, carbon foam, carbon paper, reticulated vitrified carbon, carbon cloth, molybdenum carbide, carbon nanotubes, conductive polymers, platinum, a platinized metal, cobalt complexes, manganese oxides, and lead dioxide, just to name a few. An external circuit is used to electrically connect the first electrode and the second electrode. In this embodiment, the sensor utilizes a reversed electron transport direction, by employing two half reactions, such as Reactions 7 and 8 shown below, to generate a sustainable electrical characteristic through the external circuit when the first electrode and the second electrode are electrically connected and exposed to at least one medium.

Taking lactate as an exemplary organic carbon source, the anodic reaction and the cathodic reaction occurring in the sensor of FIG. 4 are shown below.

CH₃CHOHCOO⁻+H₂O→CH₃COO⁻+CO₂+4H⁺+4e⁻ Anodic reaction (7)

O₂+4e⁻+4H⁺→2H₂O Cathodic reaction (8)

In this embodiment, electrons released from lactate oxidation in the cytoplasm are donated by the biofilm to the first electrode (i.e., the anode). As a result of electron release and donation of the released electrons to the first electrode by the electrogenic microbes in the biofilm coating or partially coating the first electrode, electrons may flow through the external circuit to the second electrode to participate in oxygen reduction. The flow of electrons is opposite from the electron flow from a metal surface to a biofilm in an actual MIC process. However, the two directions of electron flow are closely related, and therefore if a biofilm donates electrons efficiently, it may also be able to accept electrons efficiently. This means that a sustainable electrical characteristic detected by the sensor shown in FIG. 4 will indicate that the biofilm is electrogenic and thus corrosive. The generated electrical characteristic may be measured by an electrical measuring device such as a voltmeter/ammeter. In some embodiments, the biofilm type (e.g., SRB biofilm or NRB biofilm) may be detected by the sustainable voltage, and the biofilm's aggressiveness may be reflected by the sustainable current. As previously noted, calibration may be achieved by comparing the measured electrical characteristic to electrical characteristics associated with known corrosive biofilms to determine the type of corrosive biofilm present.

In one exemplary embodiment, the anodic biofilm sensor as shown in FIG. 4, may have a first electrode (i.e., anode) comprising a graphite or other materials that are not easily oxidized. For example, the standard reduction potential of Fe²⁺/Fe (−0.447 V) is similar to the standard reduction potential of carbon dioxide+acetate/lactate (−0.43 V). Because the standard reduction potentials are similar, it is possible that the iron oxidation reaction would interfere with the organic carbon oxidation reaction. Thus, a first electrode comprising a graphite or other inert material will reduce the likelihood of inaccurate readings from the sensor.

In one embodiment, an electrode may comprise a dual plate electrode comprising a first metal plate (preferably steel or the same metal as the structure) in direct contact with a second inert plate (preferably a graphite plate, or other inert, conductive material). The first metal plate may further include a porous membrane or porous coating that covers any surface of the first metal plate that is not in direct contact with the second inert plate to prevent direct attachment of a biofilm and to allow ionic species to diffuse into the medium. The first metal plate serves as an electron donor to the biofilm that forms of the second inert plate. This electrode design allows the biofilm to access electrons from metal oxidation through the conductive second inert plate. Accordingly, this electrode design will encourage the biofilm to attach to the second inert plate more closely in order to promote electrogenicity of the biofilm through more direct contact, or by forming pili between the sessile cells and the surface of the second inert plate. During sensor measurement of the electrogenicity of the biofilm, the first metal plate may be removed to eliminate any interference.

In some embodiments, an electrode may comprise carbon foam, carbon paper, reticulated vitrified carbon, carbon cloth, molybdenum carbide, carbon nanotubes, conductive polymers, platinum, a platinized metal, cobalt complexes, manganese oxides, and lead dioxide, just to name a few.

In some embodiments, a corrosive biofilm may be harvested online, inside a pipeline or from other locations where biofilms may prove to be problematic. In some embodiments, the biofilm may then be grown in either a cathodic or anodic biofilm sensor to measure the electrogenicity of the biofilm. To grow a biofilm (with an inoculum collected from a suspected biofilm contaminated site) in an offline cathodic biofilm sensor, some limited amount of organic carbon (e.g., lactate) or dissolved H₂ nutrient (for methanogens) is added to the cathodic chamber. The added amount should be limited such that as the biofilm grows, it consumes most if not all of the added nutrient. This will allow an established biofilm on the cathode to start accepting electrons from the cathode that are supplied by the anode via the external circuit. This will generate a sustainable electrical characteristic, such as a voltage and a current, that can be measured by a voltmeter/ammeter.

Similarly, to grow a biofilm in an offline anodic biofilm sensor, some limited amount of oxidant such as sulfate, nitrate, nitrite or carbon dioxide is added to the anodic chamber. When the biofilm is established on the anode, it should consume most if not all of the oxidant. Subsequently, the biofilm will use the anode as an electron acceptor instead of the oxidant and the biofilm will donate the electrons from organic carbon oxidation to the anode. This will generate a sustainable electrical characteristic, such as a voltage and a current, in the external circuit that can be measured by an electrical measuring device, such as a voltmeter/ammeter. For online anodic biofilm sensors, an artificial medium free of oxidants (e.g., oxygen, sulfate, nitrate, nitrite, etc.) may be utilized for an anodic biofilm sensor. In other embodiments, the online cathodic biofilm sensor may require an artificial medium free of organic carbon and dissolved hydrogen. In other embodiments, fluid from the biofilm's native environment may be used as the medium for testing or sensing procedures. In some embodiments, oxidants in the native medium may be removed allowing time for the biofilm to consume them while the coupon (i.e., electrode) withdrawn from a pipeline or a flow system is offline or the oxidant may be removed by precipitation. The native medium can be replaced with a medium free of oxidants to maximize sustainable electrical characteristics for the anodic biofilm sensor (FIG. 4), and organic carbon and H₂ may be removed from the medium for the cathodic biofilm sensor (FIG. 3) by allowing time for the biofilm to consume them while the coupon withdrawn from a pipeline or a flow system is offline. The medium can also be replaced with an artificially mixed medium that is free of organic carbon and H₂, but contains oxidants such as sulfate, nitrate and carbon dioxide.

In some embodiments, the novel sensors may be used for the online detection of corrosive biofilms. In some embodiments, the sensors may be strategically placed in high-risk locations such as dead-legs in a pipeline where water and nutrients tend to accumulate. In another embodiment, sensors may be placed in high-risk locations including, storage tanks and water cooling towers.

In an exemplary embodiment, a biofilm may be collected on a metal coupon (i.e., electrode) from a pipeline. Preferably, the metal coupon comprises the same material as the pipeline. Subsequently, the metal coupon is withdrawn from the pipeline, and then is treated as a cathode electrode in a sensor containing a hydrogen anode at pH 7 that provides a potential of −414 mV, as seen in FIG. 3. In some embodiments, a medium containing no reducers may be used to replace the pipeline fluid. In other embodiments, a voltmeter/ammeter may be used to measure an electrical characteristic, such as voltage and current, of the sensor. The medium may be an artificial medium or a pipeline fluid after removal of reducing compounds, such as organic carbon and dissolved H₂. Removal can mean consumption by the biofilm offline over a period of time or other means such as using an artificially mixed medium free of reducing compounds. In some embodiments, the presence of a corrosive biofilm on the coupon surface may be detected by the sensor from a sustainable electrical characteristic after one or more hours, or after allowing sufficient time for the biofilm to adapt to the new medium. In another embodiment, if no corrosive biofilm is detected, the metal coupon may be replaced in the pipeline for additional monitoring. As a result of cost-benefit analysis, readings may be repeated daily, weekly, monthly, or yearly, depending on the likelihood of biofilm formation in the system.

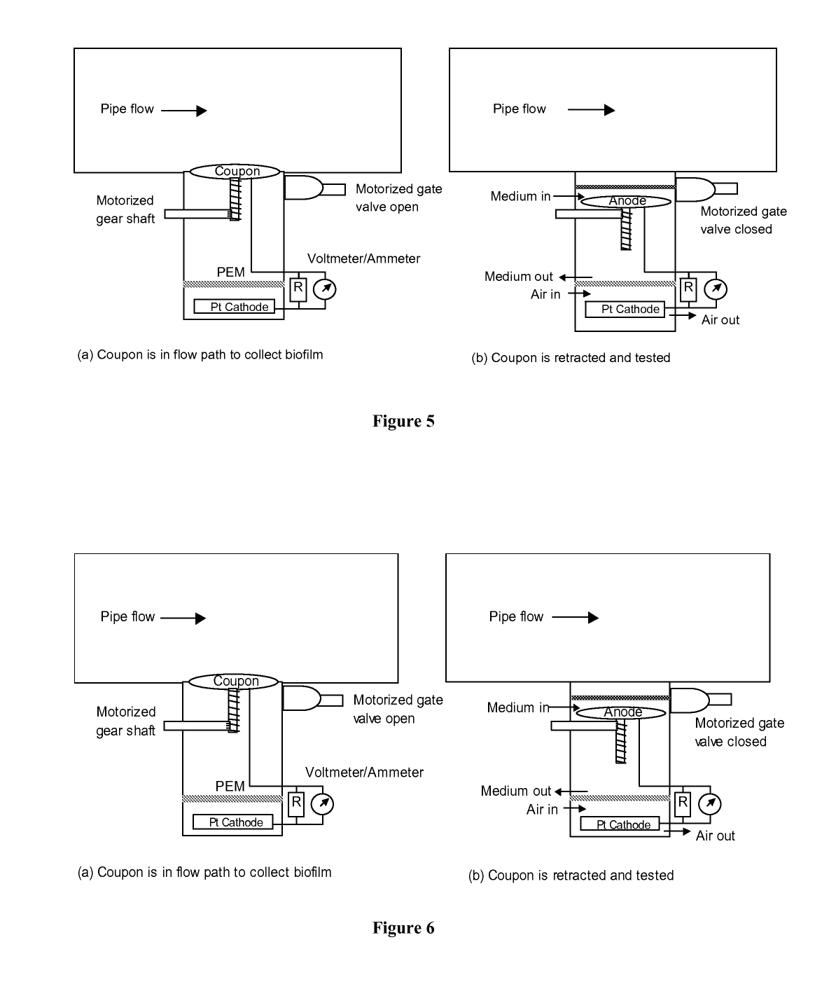

With reference to FIG. 5, an exemplary description of an online cathodic biofilm sensor is provided. A sensor may be inserted into a certain section of a pipeline that is suspected to be prone to MIC attack, such as a dead leg or a stagnant or low flow region. After a week, a month or a longer period of time, a signal may be sent to the sensor to retract the coupon (cathode electrode) into a chamber and the (cathodic) chamber is sealed, as seen in FIG. 5(b). The chamber is then automatically flushed and filled with a medium containing sulfate, nitrate, and dissolved carbon dioxide. After at least thirty minutes, a notable voltage or current may be sustainable if the biofilm is electrogenic (i.e., corrosive). To reflect the local nutritional environment best, the medium can be the local fluid that has been processed to remove any reducers (e.g., organic carbon and hydrogen) or a sufficient time has been given to allow the biofilm to consume the reducers after the biofilm is offline.

In another exemplary embodiment, an online anodic biofilm sensor may be used to collect a biofilm on a metal coupon (i.e., electrode). Preferably, the metal coupon comprises the same material as the pipeline. Subsequently, the coupon is withdrawn from the pipeline and is used as an anode electrode in the sensor, as seen in FIG. 6. The pipeline fluid is used as the medium in the anodic chamber for the biofilm coating or partially coating the anode. Sufficient time is allowed for the biofilm to consume any oxidants present in the medium. After the oxidant is almost consumed, the biofilm will begin donating electrons to the anode, which will generate a sustainable electrical characteristic indicating that the biofilm is electrogenic and corrosive. If no corrosive biofilm is detected by the sensor, the metal coupon may be reinserted in the pipeline for additional monitoring.

With continued reference to FIG. 6, an exemplary description of an online anodic biofilm sensor is provided. A sensor may be inserted into a certain section of a pipeline that is suspected to be prone to MIC attack, such as in a dead leg, or a stagnant or low flow region. After a week, a month or a longer period of time, a signal may be sent to the sensor to retract the coupon (anode electrode) into a chamber and the (anodic) chamber is sealed, as seen in FIG. 6 (b). The chamber is then automatically flushed and filled with a medium. After at least thirty minutes, a notable voltage or current may be sustainable if the biofilm is electrogenic (i.e., corrosive). To reflect the local nutritional environment best, the medium can be the local fluid that has been processed to remove any oxidants (e.g., oxygen, sulfate, nitrate, and nitrite) or a sufficient time has been given to the biofilm to consume the oxidant after the biofilm is offline.

Both cathodic and anodic biofilm sensors possess distinct advantages, especially when original pipeline fluids are used after removal of oxidants or reducers. The removal of oxidants (for an anodic biofilm sensor) may be easier than the removal of reducers (for a cathodic biofilm sensor) in some cases, and vice versa. As a result of the difficulty to selectively remove oxidants and reducers, an anodic or cathodic biofilm sensor may be more convenient than the other based upon the medium being utilized.

In some embodiments, anodic and cathodic biofilm sensors may use any variety of electrogenic microbes that may form a biofilm, including SRB such as Desulfovibrio desulfuricans and Desulfovibrio vulgaris, which have been used for anodic and cathodic biofilms in microbial fuel cell research. Other electrogenic microbes that may form a biofilm include, but are not limited to, Proteus mirabilis, Erwinia dissolven, Lactobacillus plantarum, Streptococcus lactis, Actinobacillus succinogenes, Gluconobacter oxydans, Klebsiella pneumoniae, Shewanella oneidensis, Shewanella putrefaciens IR-1, Desulfuromonas acetoxidans, Geobacter metallireducens, Geobacter sulfurreducens, Rhodoferax ferrireducens, Aeromonas hydrophile, Desulfobulbus propionicus, Pichia anomala, Rhodopseudomonas palustris, Ochrobactrum anthropi, Acidiphilium sp., Thermincola sp., Geopsychrobacter electrodiphilus, Enterobacter and Citrobacter bacteria (e.g., E. dissolvens, E. ludwigii, C. farmeri and C. amalonaticus); Eubacterium and Clostridium bacteria (e.g., Clostridium butyricum, Clostridium algidixylanolyticum, Anaeorfilum pentosovorans, Bacteroides sp., Acinebacter sp., Propionibacterium sp.); sulfate reducing bacteria including but not limited to Desulfovibrionales (e.g., Desulfovibrio desulfuricans, Desulfovibrio vulgaris, Desulfovibrio aminophilus); nitrate reducing bacteria; nitrite reducing bacteria; Desulfobacterales, and Syntrophobacterales; thiosulfate reducing anaerobes (e.g., Geotoga aestuarianis, Halanaerobium congolense, Sulfurospirillum sp.); tetracholoroethene degrading anaerobes (e.g., Sporomusa ovata); triethanolamine degrading bacteria (e.g., Acetobacterium sp.); denitrifiers (e.g., Acidovorax sp., Pseudomonas sp.); xylan degrading bacteria; Nitrospirae; Halomonas spp.; Idiomarina spp.; Marinobacter aquaeolei; Thalassospira sp.; Silicibacter sp.; Chromohalobacter sp.; Bacilli (e.g., Bacillus spp. Exiguobacterium spp.); Comamonas denitrificans; Methanobacteriales; Methanomicrobiales; and Methanosarcinales. Although all possible electrogenic microbes are not listed herein, one of ordinary skill in the art would readily be able to determine whether a microbe is electrogenic.

Examples of microbes that generally colonize and cause damage to pipelines in other industries are: Staphylococcus aureus, Methicillin-resistant Staphylococcus aureus (“MRSA”), Escherichia coli, Enterococcus fecalis, Pseudomonas aeruginosa, Aspergillus, Candida, Clostridium difficile, Staphylococcus epidermidis, and Acinobacter sp. Biofilms comprising these microbes may be used to donate electrons to an anode or to receive electrons from a cathode in a biofilm sensor. In some embodiments, the novel sensors may not elicit a response to non-corrosive biofilms, because non-corrosive biofilms are not electrogenic and are incapable of transferring or accepting electrons. In other embodiments, the novel sensors only detect electrogenic and corrosive biofilms.

In some embodiments, the new sensors may detect both the presence of a corrosive biofilm, and the aggressiveness of the biofilm toward a metal surface by comparing sensor output data to biofilm standard data that has been collected as a result of MIC pitting studies, such as studies conducted in anaerobic vials. In some embodiments, the sensors may use either a zero resistance ammeter (ZRA) or a picoammeter as opposed to the expensive potentiostats associated with LPR technologies. In some embodiments, a standard multimeter or voltmeter/ammeter combo meter may be used in place of a ZRA for preliminary sensing. In another embodiment, a visual sensor will provide a visual signal at a predetermined output current and/or voltage threshold. In another embodiment, the visual signal will be the illumination of a light, such as a light emitting diode (LED) to notify an inspector. Phototransistors may be provided in the external circuit to amplify the sustainable electrical characteristic, such as the voltage and/or current, to trigger the visual signal to alert an inspector. The inspector may go to the site where the sensor is located and use an electrical measuring device to confirm the presence of a sustainable electrical characteristic. Additionally, the inspector may retrieve the electrode for offline analysis. In other embodiments, the sensor may be configured to send a signal to a GPS, GSM, or WiFi device as part of a signaling system to notify the inspector of possible corrosive biofilm buildup or MIC. A more expensive and precise voltmeter/ammeter such as a potentiostat may be brought on site for more precise measurements of voltage and current output.

In some embodiments, the sensor may be miniaturized to produce a biofilm microsensor (BMS) for online or offline uses. In other embodiments, a biofilm microsensor may be placed upon a chip or integrated into microcircuits to yield miniaturized devices for measurements in systems of reduced diameter or size. In addition to the exemplary embodiments of sensors as shown in FIGS. 3-6, a variety of other sensor embodiments are possible. Contemplated herein are sensors that contain an open anode chamber which may be impressed on a metal surface to seal a chamber. The backside of the metal surface may then be wired to the cathode to measure an electrical characteristic, such as voltage and current. For very weak biofilms, electron mediators, including, but not limited to, flavin adenine dinulceotide (FAD), riboflavin, ferricyanide, thionine, humic acids, viologens, cytochromes, metallorganics, and nicotinamide adenine dinucleotide (NAD), just to name a few, may be added to the medium to amplify the sustainable electrical characteristic.

Contemplated herein are a number of structurally diverse sensors that may be formed as, but not limited to, channels with removable plates, online plug sensors (e.g., threaded, tension-fit, clip-fit, washer-fit, collar-fit, and mechanically immobilized), multiport biofilm sensors, rack and plate sensors for batch sampling, and ball or disk sensors.

Contemplated herein is a sensor comprising a flow cell or channel, a removable coupon or plate, and a fastening device to secure the plate to the flow chamber. The plate may be manually removed from the flow channel for offline sampling by insertion into an external system. The electrogenicity of microbes may be tested in the external system, or physical analysis of the coupon may be completed, including scanning electron microscopy (SEM) and atomic force microscopy (AFM), energy dispersive spectrometry (EDS) and X-Ray diffraction (XRD).

Contemplated herein are a series of threaded plug sensors that are configured to engage a threaded opening of a structure, such as a pipeline, containing at least one medium. In some embodiments, the plug sensor may be secured via tension, or by devices including, clips, washers, nuts, screws, o-rings, pins, collars, or other means of mechanical immobilization. Also contemplated herein, is a multiport sensor in which the device contains two or more individual ports over which a sealing device (e.g., plate, coupon, plug, ball, disk, or other metallic object) may be placed so that a portion of the surface of the metallic object is in contact with a medium that may be prone to biofilm growth. In other embodiments, the sealing device may be held in place via a previously described method and any number of sealing devices from one to all devices on said multiport sensor may be removed for testing either at once or at different time points.

Also contemplated herein, are ball or disk devices in which a portion of the ball or disk may be exposed to a fluid medium for sample collection of a biofilm before alteration of the position of the ball or disk provides access to the sample for either online or offline testing to establish either the presence and/or aggressiveness of an electrogenic biofilm. In some embodiments, the ball or disk may be supported by a rod along an axis. In other embodiments, tension may be used to secure the ball or disk in place for either sample collection or for data collection experiments.

In one embodiment, a series of biofilm cell or planktonic cell samples are isolated from the field. Each sample is tested individually in a sensor in the lab using a medium that reflects the field condition best. In some embodiments, the culture medium may be local fluid (e.g., seawater, pipeline fluid, etc.) collected from the field. After a biofilm is established on the anode surface or the cathode surface, the growth medium is replaced with a new medium and the system is allowed to equilibrate. The new medium may be free of oxidants (if an anodic biofilm sensor is used) or reducers (if a cathodic biofilm sensor is used) which may allow voltage and current responses.

In another embodiment, a vial with a Nafion™ membrane sealed bottom is used to sample field biofilm or planktonic cells. The vial contains a medium to promote biofilm growth on reusable platinized, stainless steel, or other metals in the vial. An oxygen scavenger such as cysteine may be added to the medium to remove oxygen in order to promote the growth of an anaerobic biofilm on the metal surface. After hours or a few days, a biofilm may form on the metal surface. The medium may be replaced with a new medium, such as an electrolytic solution, that is free of organic carbon and hydrogen. The vial is then used as the cathodic chamber in a microbial fuel cell with a tantalum/tantalum pentoxide anode electrode in the new medium at pH 7. The electrical characteristics, such as the voltage and the current, are measured to indicate whether the biofilm is electrogenic, and thus corrosive. In some embodiments, the new medium may comprise a MgSO4 solution (0.1% to 2% w/w), a NaCl solution (0.1% to 2% w/w) or a PBS buffer, just to name a few.

In yet another embodiment, a vial with a Nafion™ membrane sealed bottom or side is used to sample field biofilm or planktonic cells. The vial contains a medium to promote biofilm growth on a reusable platinized, stainless steel, or other metal electrode in the vial. An oxygen scavenger such as cysteine may be added to the medium to remove oxygen in order to promote the growth of an anaerobic biofilm on the electrode surface. After hours or a few days, a biofilm may form on the electrode surface. The medium is replaced with a new medium comprising organic carbon, but free of oxidants such as sulfate, nitrate and carbon dioxide. The vial is then used as the anodic chamber in a microbial fuel cell with an oxygen half cell. The electrical characteristics, such as the voltage and the current, are measured to indicate whether the biofilm is electrogenic, and thus corrosive.

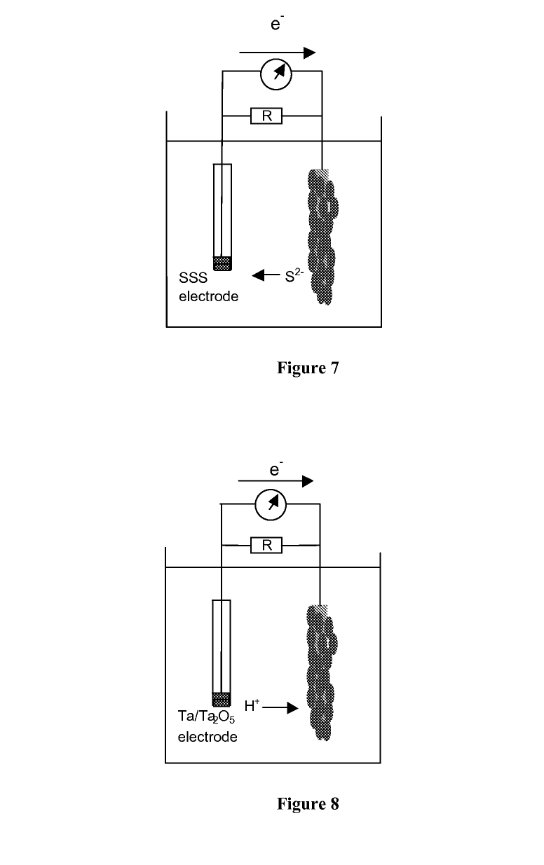

Referring now to FIG. 7, an additional exemplary embodiment of a sensor for passively detecting a corrosive biofilm is shown. As seen in FIG. 7, the first electrode comprises a silver/silver sulfide (Ag/Ag₂S or SSS) electrode and operates as an anode. The first electrode is electrically connected to a second electrode by an external circuit. The external circuit may comprise a resistor or an electrical measuring device such as a multimeter, a high impedance voltmeter, or a low (or zero) resistance ammeter, just to name a few. The second electrode operates as a cathode and may be selected from the group consisting of a graphite, a metal, and a metal alloy. With continued reference to FIG. 7, the second electrode is partially coated by a biofilm. A sustainable electrical characteristic, such as voltage and current, generated when the first electrode and the second electrode are electrically connected and exposed to at least one medium indicates that the biofilm partially coating the second electrode is electrogenic, and thus corrosive.

Utilizing a solid state silver/silver sulfide (Ag/Ag₂S or SSS) electrode as the first electrode (i.e., anode) provides several advantages. First, the SSS electrode is an inexpensive and rigid electrode that comprises a wire linked to a silver disk coated with solid silver sulfide. The half cell reactions for the sensor utilizing a silver/silver sulfide electrode are as follows:

2Ag+S²⁻→Ag₂S+2e⁻ Anodic reaction (9)

SO₄²⁻+9H⁺+8e⁻→HS⁻+4H₂O Cathodic reaction (10)

Electrons generated by the anodic reaction (9) are utilized by the biofilm for sulfate reduction (10). The arrows shown in FIG. 7 depict the external and internal electron flow in the sensor. The SSS electrode standard potential is weakly dependent on the sulfide ion (S²⁻) concentration in the medium. The SSS electrode requires an amount of sulfide ion (S²⁻) present in the medium to operate as a reference electrode, such as a concentration of at least 0.001 ppm. Such a trace amount of sulfide ion may be met by pipeline fluids, seawater, wastewater, municipal water, run-off water, etc. This means that even for non-sulfate reducing bacteria systems, an SSS electrode may still be used. However, the SSS electrode can also tolerate a high sulfide concentration. Continuous current flow is not needed for the purposes of biofilm detection. Therefore, an SSS electrode may be utilized in a medium having a low sulfide ion concentration without depleting the sulfide ion. Theoretically, the open-circuit potential of the sensor shown in FIG. 7 is roughly 0.49 V, which is calculated by using the standard potentials for silver oxidation (Reaction 9: 0.71 V) and sulfate reduction (Reaction 10: −0.217 V). Actual readings will differ as the sulfide concentration and temperature will change the potentials according to the Nernst equation. Moreover, activation and concentration overpotentials will reduce the measurable electrical characteristic, such as the voltage output. If the sustainable electrical characteristic of interest is the voltage output, a high impedance voltmeter is a preferred electrical measuring device. As previously noted, when the sensor detects a sustainable voltage, this indicates the presence of an electrogenic and corrosive biofilm, and can also indicate the type of electrogenic and corrosive biofilm by comparing the measured voltage to voltages of known electrogenic and corrosive biofilm compositions. Additionally, how fast an electrogenic biofilm pits a metal substrate depends on how fast the biofilm can transport and utilize electrons. Thus, current output from the sensor is a good indicator of the pitting rate (i.e., corrosion rate) of the biofilm. To provide a sensitive and precise reading of the current, a zero resistance ammeter is a preferred electrical measuring device.

A silver/silver sulfide electrode may be made inexpensively by dipping a silver disk or rod into an alkaline sodium sulfide solution. An external voltage and a stainless steel electrode may be used to deposit the sodium sulfide onto the silver surface at a faster rate. Additionally, silver/silver sulfide electrodes are commercially available as a reference electrode.

In addition to the silver/silver sulfide electrode, the first electrode (i.e., anode) may be a solid-state electrode selected from the group consisting of a tantalum/tantalum pentoxide (Ta/Ta₂O₅) electrode, an ion selective electrode (ISE), and an ion-selective field effect transistor. The important feature of such an electrode is that the electrode should be able to provide a standard reduction potential that is substantially more negative than the standard reduction potential of ferrous ion/iron (Fe²⁺/Fe), which is −0.447 V. A very negative standard reduction potential means that the oxidation reaction is more favorable and likely to occur. This is important because an electrode with a very negative standard reduction potential, such as that for the SSS electrode (−0.71 V), suppresses iron oxidation that can locally supply electrons to the biofilm, which can cause the sensor to produce no voltage or a faulty voltage. When this type of first electrode (i.e., anode) is utilized, the second electrode may comprise an iron-based metal instead of having to use a graphite or other inert electrode material. Using an iron-based metal has a distinct advantage in that the second electrode may comprise the same material as a structure in the field (e.g., a pipeline, a storage tank, a heat exchanger, etc.). Accordingly, the biofilm would be formed on a second electrode comprising the same material as the structure in the field, as opposed to a different material such as a graphite.

Another advantage of using a first electrode (i.e., anode) with a very negative standard reduction potential is that there is no need to remove organic carbon from the medium. For example, organic carbon oxidation may be suppressed on the surface of the second electrode (i.e., cathode) because electrons are readily available on the surface of the second electrode from the external circuit. The very negative standard reduction potential makes this possible, which is similar to the aforementioned iron oxidation suppression. This requires the biofilm present on the second electrode to be electrogenic, so that the biofilm is able to accept electrons from the second electrode. Still another advantage of utilizing an anode electrode with a very negative standard reduction potential, such as a Ta/Ta₂O₅ electrode, is that the proton exchange membrane may be eliminated.

The external circuit of the sensor only needs to be electrically connected to the first electrode and the second electrode periodically to measure an electrical characteristic such as a voltage or current. Most of the time, the external circuit is open, which allows the biofilm to form on and corrode the second electrode (i.e., cathode). In some embodiments, the second electrode, or cathode, may be harvested for MIC pitting examination offline.

Referring now to FIG. 8, another exemplary embodiment of a sensor for passively detecting a corrosive biofilm is shown. As seen in FIG. 7, the first electrode comprises a tantalum/tantalum pentoxide (Ta/Ta₂O₅) electrode and operates as an anode. The first electrode is electrically connected to a second electrode by an external circuit. The external circuit may comprise a resistor or an electrical measuring device such as a multimeter, a high impedance voltmeter, or a low (or zero) resistance ammeter, just to name a few. The second electrode operates as a cathode and may be selected from the group consisting of a graphite, a metal, and a metal alloy. With continued reference to FIG. 8, the second electrode is partially coated by a biofilm. A sustainable electrical characteristic, such as voltage and current, generated when the first electrode and the second electrode are electrically connected and exposed to at least one medium indicates that the biofilm partially coating the second electrode is electrogenic, and thus corrosive. In this embodiment, the at least one medium may comprise 0.2% (w/w) or higher (e.g., 1% (w/w)) MgSO₄ or NaCl solution, or a buffer solution such as phosphate buffered saline (PBS).

The tantalum/tantalum pentoxide (Ta/Ta₂O₅) electrode has a standard reduction potential of −0.75 V at pH 7. The half cell reaction for a sensor utilizing a tantalum/tantalum pentoxide (Ta/Ta₂O₅) electrode is as follows:

2Ta+5H₂O→Ta₂O₅+10H⁺+10e⁻ Anodic reaction (11)

The oxidation reaction (11) has a potential of +0.75 V and may be coupled with a reduction reaction, such as a sulfate reduction reaction (−0.217 V) or a nitrate reduction reaction (+0.76 V) as shown below.

SO₄²⁻+9H⁺+8e⁻→HS⁻+4H₂O Sulfate reduction (12)

2NO₃⁻+12H⁺+10e⁻→N₂+6H₂O Nitrate reduction (13)

Theoretically, the open-circuit potential of the sensor shown in FIG. 8 for a sulfate reducing bacteria is roughly 0.53 V, and the open-circuit potential for a nitrate reducing bacteria is roughly 1.51 V. Actual readings will be lower due to activation and concentration overpotentials, which may reduce the sustainable electrical characteristic, such as the voltage output. A tantalum/tantalum pentoxide (Ta/Ta₂O₅) electrode may be prepared by exposing pure tantalum to oxygen at temperatures above 1000° C., or to molten potassium nitrate (KNO₃).

As previously mentioned, the first electrode (i.e., anode) may comprise an ion-selective field effect transistor (ISFET) if the ISFET provides a sufficiently negative standard reduction potential. An ion-selective field effect transistor may allow miniature sensors to be produced, with the size being primarily dependent on how large a cathodic surface area is desired.

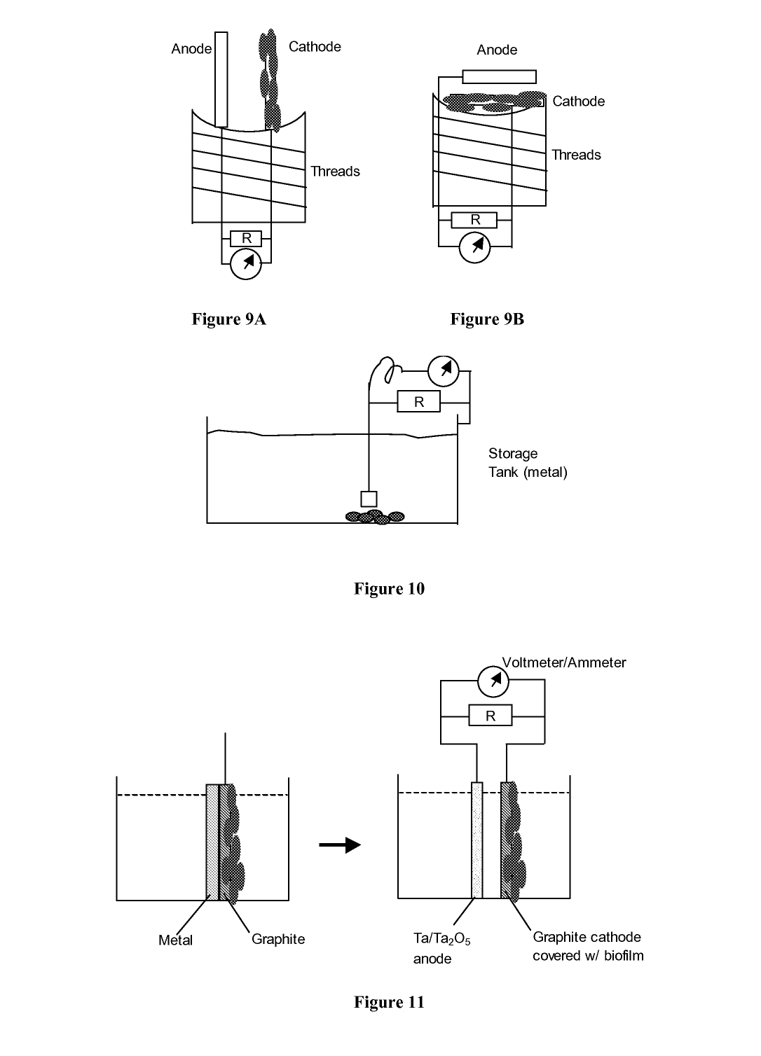

With reference now to FIGS. 9A and 9B, additional exemplary embodiments of a sensor for passively detecting a corrosive biofilm. In these embodiments, the sensor includes a housing for supporting at least one of the first electrode (i.e., anode) and the second electrode (i.e., cathode). The housing may be configured for engagement with a structure containing at least one medium such that at least a portion of the first electrode and at least a portion of the second electrode are exposed to the at least one medium. For example, the housing may comprise a threaded hex plug for engaging a threaded opening in a structure such as a pipe or storage tank containing a medium containing microbes capable of forming a biofilm. As seen in FIGS. 9A and 9B, the first electrode and the second electrode may be arranged vertically or horizontally on the housing. Moreover, the housing may have a surface contour that matches the surface contour of the structure. For example, if the structure is a pipe, the housing may have a contour that matches the pipe, or if the structure has a flat surface, such as a flat wall of a storage tank, the housing may have a corresponding flat surface for mounting.

In the embodiments shown in FIGS. 9A and 9B, the second electrode (i.e., cathode) may be selected from the group consisting of a graphite, a metal, and a metal alloy, and the second electrode is partially coated by a biofilm. In a particular embodiment, the housing itself may comprise the second electrode. The first electrode (i.e., anode) may be selected from the group consisting of a tantalum/tantalum pentoxide electrode, a silver/silver sulfide electrode, an ion selective electrode, and an ion-selective field effect transistor. As previously noted, the external circuit of the sensor only needs to be electrically connected to the first electrode and the second electrode periodically to measure an electrical characteristic such as a voltage or current. Moreover, the electrical characteristic measured by the sensor may be compared to electrical characteristics, such as voltage, of known biofilm compositions on the same type of electrode surface (i.e., cathode surface) measured offline to determine the type of biofilm present.

In some embodiments, the presence of oxygen in contact with an electrode partially coated with a biofilm (i.e., a biocathode) may interfere with sensor output. Oxygen will cause an abnormally large voltage output because oxygen has a very large standard reduction potential (+0.818 V). If the electrode is completely coated with a biofilm, the electrode surface may still be anaerobic underneath the biofilm due to the consumption of oxygen by aerobic biofilm cells in the outer layer of the biofilm consortium. In one embodiment, an oxygen scavenger, such as cysteine, may be added to the medium to remove oxygen. In another embodiment, if a sensor is suspected of experiencing oxygen interference, the measurement of an electrical characteristic may be performed offline by using nitrogen sparging or an oxygen scavenger chemical to remove oxygen.

In other embodiments, the anode electrode in a biocathode type sensor may become fouled by a biofilm buildup. In most cases, the fouling of the anode electrode will not substantially impact the sensor operation. However, the anode may be cleaned periodically for maintenance. In cases where anode electrode fouling is a problem, the anode electrode may be covered by a membrane, such as a 0.1 micron microfiltration membrane or a large-pore ultrafiltration membrane (e.g., UF 100,000), to block the microbes and their spores, while still allowing the ionic species to diffuse through. In some embodiments, an ion-exchange membrane may be used. Still further, placing the anode electrode surface downward can sometimes slow down biofilm buildup.

Referring now to FIG. 10, an embodiment of a biofilm spot sensor is shown. This particular embodiment is useful for detecting an electrogenic biofilm on a metal structure, such as a metal storage tank. As seen in FIG. 10, the biofilm forms on the surface of the metal structure, which operates as the second electrode (i.e., cathode) of the sensor. The first electrode (i.e., anode) may be selected from the group consisting of a tantalum/tantalum pentoxide electrode, a silver/silver sulfide electrode, an ion selective electrode, and an ion-selective field effect transistor. The first electrode is electrically connected to the second electrode by an external circuit. The external circuit may comprise a resistor or an electrical measuring device such as a multimeter, a high impedance voltmeter, or a low (or zero) resistance ammeter, just to name a few. When the first electrode is positioned very close to the biofilm, an electrical characteristic, such as a voltage, is generated that corresponds to the type of reduction reaction occurring on the second electrode beneath the biofilm. If the first electrode is positioned too far away from the biofilm, concentration overpotential due to internal resistance (i.e., ion transport resistance in the medium) will cause the voltage to approach zero. Therefore, the sensor may be capable of pinpointing a spot on the surface of a metal structure that has an electrogenic biofilm even if the biofilm does not completely cover the surface of the metal structure.

Referring now to FIG. 11, a drop-in biofilm sensor module is shown. In this embodiment, the sensor comprises a chamber at least partially enclosing at least one first electrode, which may be placed into a structure containing at least one medium, such as a storage tank, or a dead-leg of a pipeline, or any place where biofilm contamination is suspected. The chamber may be permeable or may include an opening to allow access to the interior of the chamber so that the medium containing microbes may enter the chamber. This particular embodiment is well-suited for detecting electrogenic biofilms in batch units (e.g., water towers, cooling towers, holding tanks, or sewage cisterns) suspected of containing media with electrogenic microbes that can form corrosive biofilms. After lowering or suspending the sensor module into the medium and allowing a sufficient time (hours to a few days) for a biofilm to at least partially coat the first electrode, the sensor module may be retrieved. The first electrode at least partially coated by the biofilm may serve as the cathode electrode while a newly inserted second electrode (e.g., a tantalum/tantalum pentoxide electrode) may serve as the anode electrode. The first electrode and the second electrode may then be electrically connected by an external circuit, such as a voltmeter or ammeter or a base station, to determine whether a sustainable electrical characteristic is generated, which would indicate the presence of an electrogenic biofilm. The base station may be a portable device capable of accurately measuring various electrical characteristics and capable of recording, storing, and/or writing the measured data. For example, the base station may record voltage and current output data and write the output data to a memory device, such as a memory card.

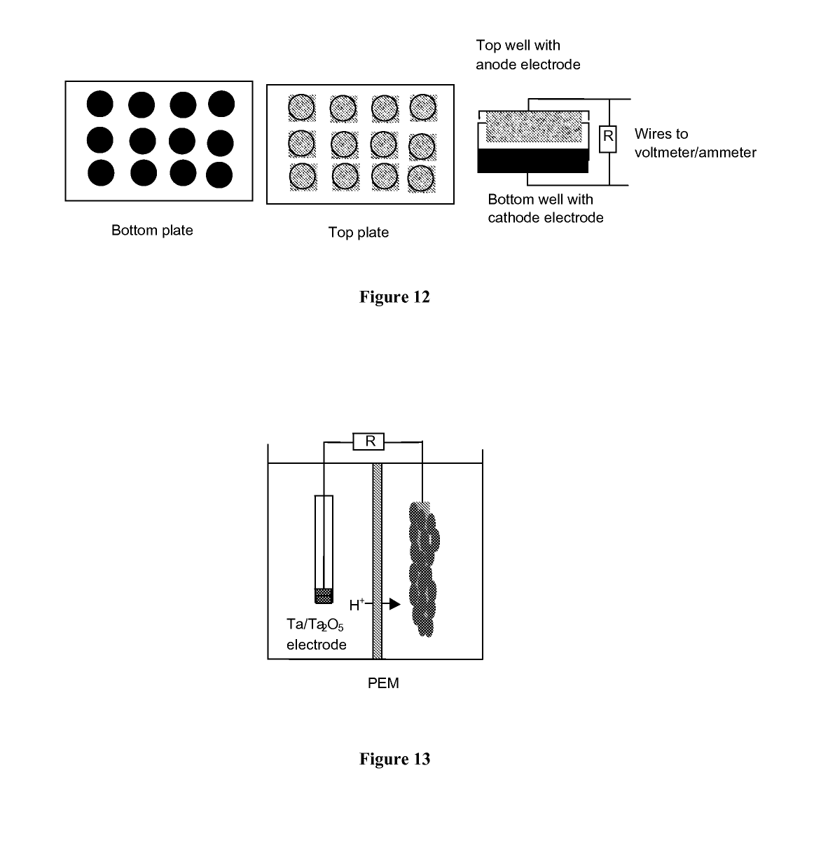

With reference now to FIG. 12, an additional embodiment of a sensor for passively detecting an electrogenic and corrosive biofilm is shown. In this embodiment, the sensor is in the form of an array for screening various media to determine whether the media contains electrogenic microbes capable of forming a corrosive biofilm. As seen in FIG. 12, the sensor may further comprise a top plate having a plurality of top plate wells and a bottom plate having a plurality of bottom plate wells. Each of the plurality of top plate wells includes a first electrode (i.e., anode) having a first electrode lead wire. Each first electrode may be selected from the group consisting of a tantalum/tantalum pentoxide electrode, a silver/silver sulfide electrode, an ion selective electrode, and an ion-selective field effect transistor. Similar to the top plate, each of the plurality of bottom plate wells includes a second electrode (i.e., cathode) having a second electrode lead wire. The second electrode may be selected from the group consisting of a graphite, a metal and a metal alloy. At least one medium capable of forming a biofilm on the second electrode is introduced into each of the plurality of bottom plate wells. After a medium is introduced into each of the plurality of bottom plate wells, the bottom plate may be incubated anaerobically to allow biofilms to form on the second electrodes. The top plate is configured to communicate with the bottom plate such that the first electrode in one of the plurality of top plate wells is in contact with the at least one medium contained in one of the bottom plate wells. A sustainable electrical characteristic, such as a voltage or current, generated when a first electrode lead wire and a corresponding second electrode lead wire are electrically connected by an external circuit indicates that an electrogenic, and thus corrosive, biofilm is present. As previously noted, the measured current correlates to the aggressiveness of the biofilm in MIC, while the voltage output can be used to indicate the presence of a biofilm and even the type of biofilm. Additionally, the current density based on the biofilm-covered cathodic surface area is a measurement of the ability of the biofilm to generate electricity. This measurement is particularly useful to screen various electrogenic biofilms to determine the best microbes to utilize in microbial fuel cell devices.

The embodiment shown in FIG. 12 has several advantages. First, no costly proton exchange membrane (e.g., Nafion™ membrane) is required to screen multiple suspected biofilm-forming liquid samples. Next, the top plate and the bottom plate are autoclavable for sterilization if noncorrosive cathodes are used (e.g., graphite and stainless steel). The plates are also reusable after cleaning and cheap enough to be disposable. Moreover, the sensor array is convenient to use and is field deployable. The sensor array also provides an advantage over kits currently available, such as SRB kits, in that the sensor array can directly an electrogenic biofilm and its corrosive ability.

An exemplary method for passively detecting a corrosive biofilm includes the following general steps: a) exposing a first electrode to at least one medium containing microbes capable of forming a biofilm; b) allowing a biofilm to form on at least a portion of the first electrode; c) electrically connecting the first electrode having the biofilm formed on a portion thereof to a second electrode; and d) measuring an electrical characteristic generated by the electrically coupled first electrode and second electrode to determine whether the biofilm is electrogenic.

As previously mentioned, the first electrode and the second electrode may function either as an anode or as a cathode. For purposes of discussing the steps in the exemplary method presented above, the first electrode will operate as a cathode, while the second electrode will operate as an anode. Thus, in one embodiment, the first electrode is selected from the group consisting of a graphite, a metal, and a metal alloy, and the second electrode is selected from the group consisting of a tantalum/tantalum pentoxide electrode, a silver/silver sulfide electrode, an ion selective electrode, and an ion-selective field effect transistor.

The step of measuring an electrical characteristic may be accomplished by using an electrical measuring device such as a multimeter, a high impedance voltmeter, or a low (or zero) resistance ammeter, just to name a few. As previously discussed, the electrical characteristic may comprise at least one of a voltage and a current. In one particular embodiment, steps c) and d) of the exemplary method may be performed simultaneously by electrically connecting the first electrode having the biofilm formed on a portion thereof to the second electrode with a high impedance voltmeter. In another embodiment, steps c) and d) of the exemplary method may be performed simultaneously by electrically connecting the first electrode having the biofilm formed on a portion thereof to the second electrode with a zero resistance ammeter.

In yet another embodiment, the method may further comprise the step of comparing a measured electrical characteristic to electrical characteristics associated with known corrosive biofilm compositions to determine the type of corrosive biofilm present. For example, the measured voltage may be compared to the voltages of know corrosive biofilm compositions, and a measured voltage similar to the voltage of a known biofilm provides an indication of the type of biofilm present. Similarly, a measured current may correlate to the aggressiveness of biofilm present, as discussed in detail above.

In an additional embodiment, after step b) and before step c), the exemplary method may further comprise the steps of: i) removing the first electrode having the biofilm formed on a portion thereof from the at least one medium containing microbes capable of forming a biofilm; and ii) placing the first electrode having the biofilm formed on a portion thereof and the second electrode in a medium different from the at least one medium containing microbes capable of forming a biofilm. In this particular embodiment, a biofilm may form on the first electrode online, and subsequently the first electrode and its biofilm may be removed and tested for electrogenicity in an offline sensor containing a different medium, or in an online sensor, such as shown in FIGS. 5 and 6, which allows a different medium to be introduced to the sensor.

This description is provided to describe the scope of contemplated methods and devices for passively detecting an electrogenic, and thus corrosive biofilm. However, the previously described methods and devices may be embodied in different forms and such methods and devices should not be construed as limited to the previously stated embodiments. Rather, these embodiments are provided so that this disclosure will be thorough and complete, and will fully convey the scope of the methods and devices to those of ordinary skill in the art.

### EXAMPLE

### Formation of an Electrogenic Biofilm

For convenience, an existing dual-chamber microbiological fuel cell (MFC) with a Nafion™ proton exchange membrane (PEM) was used to form electrogenic biofilms, as seen in FIG. 13. In the MFC, the anode electrode was a tantalum/tantalum pentoxide (Ta/Ta₂O₅) electrode and the cathode electrode was a graphite electrode. The tantalum/tantalum pentoxide electrode was electrically connected to the graphite electrode via an external circuit comprising a 1 kΩ resistor. The medium in the anodic chamber was distilled water, while 200 ml of deoxygenated and autoclaved ATCC 1249 medium without lactate and citrate was used to fill the cathodic chamber. To keep the cathodic chamber anaerobic, 100 ppm cysteine (an oxygen scavenger) was added to the cathodic chamber medium. The anaerobic cathodic chamber was inoculated with Desulfovibrio vulgaris (ATCC 7757) bacterium, which is a common strain of SRB. The SRB cell concentration right after inoculation was around 10⁶ cells/ml. By electrically connecting the two electrodes, sessile cells on the graphite electrode were encouraged to utilize electrons supplied by the anode (tantalum/tantalum pentoxide electrode). This promoted the electrogenecity of the biofilm.

After three days, an established SRB biofilm formed on the graphite electrode. The biofilm utilized the electrons supplied by the anode electrode through the external circuit for the oxidation of sulfate in the cathodic chamber. Two identical graphite electrodes partially coated with biofilms were harvested from the MFC. The two graphite electrodes were rinsed with deoxygenated MgSO₄ solution (0.2% w/w, as in the ATCC 1249 medium) to remove loosely attached planktonic cells. One graphite cathode was treated with 4% (w/w) glutaraldehyde for 8 hours to kill the biofilm cells. These operations were conducted in a glovebox with a positive nitrogen gas pressure to prevent oxygen contamination.

### Testing for Electrogenicity

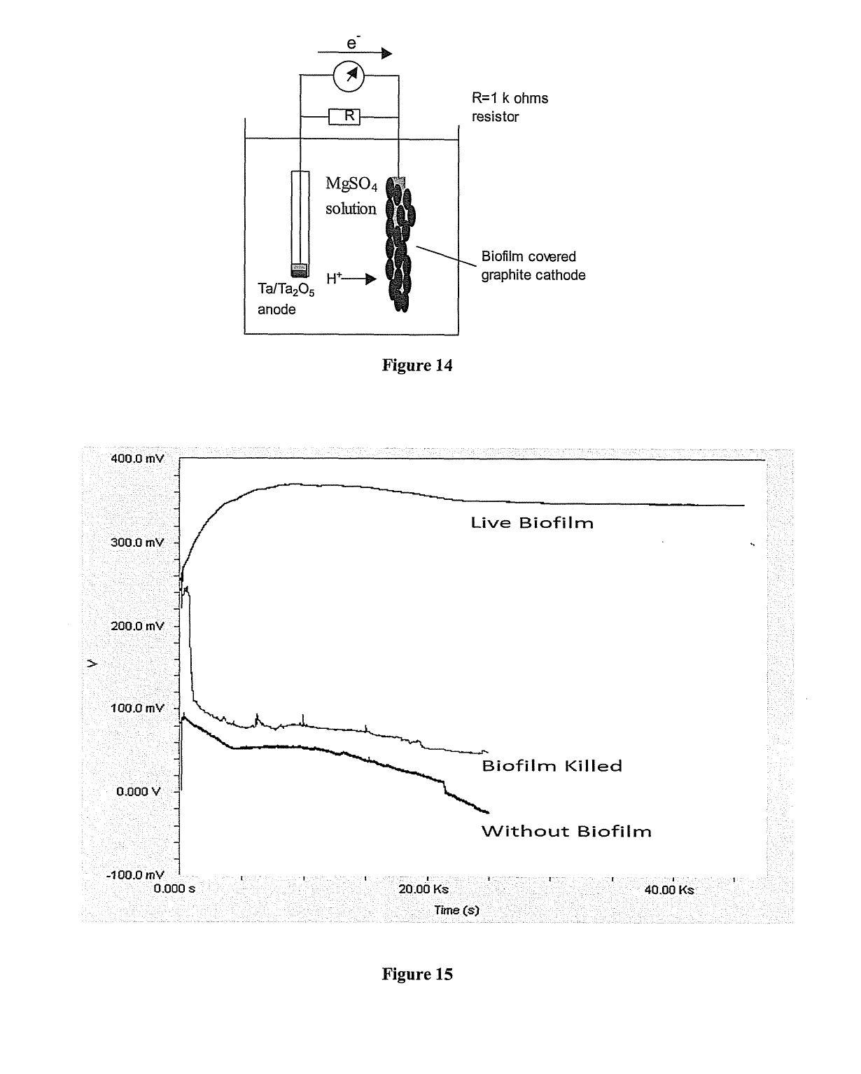

Referring now to FIG. 14, an embodiment of a sensor used to passively detect the electrogenicity, and hence the corrosiveness, of a biofilm is shown. The graphite cathode electrode partially coated with the biofilm harvested from the MFC of FIG. 13 was removed and was electrically connected to a tantalum/tantalum pentoxide (Ta/Ta₂O₅) anode electrode via an external circuit with a 1 kΩ load. A Gamry PC3™ potentiostat was used to measure the voltage output across the external load. The medium comprised a deoxygenated magnesium sulfate (MgSO₄) solution. The sensor did not need a proton exchange membrane. Two control cathode electrodes were used for comparison with the graphite cathode electrode partially coated with the biofilm. One control cathode electrode was a graphite electrode never exposed to SRB, while the other was a graphite electrode partially coated with a biofilm that was subsequently killed by the application of glutaraldehyde as described above.

### Results

FIG. 15 shows the voltage output responses (in millivolts) versus time (in kiloseconds) using the different graphite cathode electrodes in three separate measurements. The results indicate that without a live biofilm on the graphite cathode electrode, the voltage output decayed relatively quickly toward zero. This was because the non-catalytic graphite cathode electrodes could not perform sulfate reduction using the electrons supplied from the anode electrode via the external circuit. On the contrary, with a living, electrogenic SRB biofilm on the graphite cathode electrode, sulfate reduction on the graphite cathode electrode occurred by the electrogenic SRB biofilm utilizing the electrons supplied via the external circuit by the Ta/Ta₂O₅ anode electrode. In the case of the live biofilm, the voltage output increased and then started to decrease slowly. The voltage output was between 300 mV to 400 mV, which is sufficiently large for biofilm detection purposes. This voltage was less than the theoretical voltage (˜0.533 V) calculated from the standard potentials of a Ta/Ta₂O₅ anode (−0.750 V for reduction at pH 7, or 0.750 V for oxidation at pH 7) and a sulfate-reduction biocathode (−0.217 V) because of losses due to activation overpotential and concentration overpotential. Additionally, the voltage measurements were taken across the external load, which had a resistance that was smaller than the overall resistance of the cell in FIG. 14, which included an internal resistance and the external load.

What is claimed is:

1. A method for passively detecting a corrosive biofilm, comprising the steps of:
a) exposing a first electrode to at least one medium containing microbes capable of forming a biofilm;
b) allowing a biofilm to form on at least a portion of the first electrode;
c) electrically connecting the first electrode having the biofilm formed on at least a portion thereof to a second electrode; and
d) measuring an electrical characteristic generated by the electrically connected first electrode and second electrode to determine whether the biofilm is electrogenic.

2. The method according to claim 1, wherein the electrical characteristic comprises at least one of a voltage and a current.

3. The method according to claim 1, wherein the first electrode is selected from the group consisting of a graphite, a metal, and a metal alloy; and the second electrode is selected from the group consisting of a tantalum/tantalum pentoxide electrode, a silver/silver sulfide electrode, an ion selective electrode, and an ion-selective field effect transistor.

4. The method according to claim 1, wherein the biofilm comprises at least one electrogenic microbe.

5. The method according to claim 1, wherein after step b) and before step c), the method further comprises the steps of:
i) removing the first electrode having the biofilm formed on a portion thereof from the at least one medium containing microbes capable of forming a biofilm; and
ii) placing the first electrode having the biofilm formed on a portion thereof and the second electrode in a medium different from the at least one medium containing microbes capable of forming a biofilm.

6. The method according to claim 1, wherein steps c) and d) are performed simultaneously by electrically connecting the first electrode having the biofilm formed on a portion thereof to the second electrode with a high impedance voltmeter.

7. The method according to claim 1, wherein steps c) and d) are performed simultaneously by electrically connecting the first electrode having the biofilm formed on a portion thereof to the second electrode with a voltmeter/ammeter combo meter.

8. The method according to claim 1, further comprising the step of comparing the measured electrical characteristic to electrical characteristics associated with known corrosive biofilm compositions to determine the type of corrosive biofilm present.

9. A sensor for passively detecting a corrosive biofilm, the sensor comprising:
a) at least one first electrode;
b) at least one second electrode; and
c) an external circuit for electrically connecting the first electrode to the second electrode;
wherein at least one of the first electrode and the second electrode is capable of being at least partially coated by a biofilm; and
whereby a sustainable electrical characteristic generated when the first electrode and the second electrode are electrically connected and exposed to at least one medium indicates that the biofilm is electrogenic.

10. The sensor according to claim 9, wherein the first electrode is selected from the group consisting of: a tantalum/tantalum pentoxide electrode, a silver/silver sulfide electrode, an ion selective electrode, and an ion-selective field effect transistor; and the second electrode is selected from the group consisting of a graphite, a metal, and a metal alloy.

11. The sensor according to claim 10, wherein the second electrode is partially coated by the biofilm.

12. The sensor according to claim 9, wherein the biofilm comprises at least one electrogenic microbe.

13. The sensor according to claim 9, further comprising a housing for supporting at least one of the first electrode and the second electrode, the housing configured for engagement with a structure containing the at least one medium such that at least a portion of the first electrode and at least a portion of the second electrode are exposed to the at least one medium.

14. The sensor according to claim 9, further comprising a chamber enclosing at least a portion of the first electrode and at least a portion of the second electrode, the chamber configured so that the at least one medium contacts the enclosed portion of the first electrode and the enclosed portion of the second electrode.

15. The sensor according to claim 9, further comprising:
a top plate having a plurality of top plate wells, wherein each of the plurality of top plate wells includes a first electrode having a first electrode lead wire, the first electrode comprising tantalum/tantalum pentoxide;
a bottom plate having a plurality of bottom plate wells, wherein each of the plurality of bottom plate wells includes a second electrode having a second electrode lead wire, and each of the plurality of bottom plate wells contains at least one medium capable of forming a biofilm on the second electrode;
the top plate communicating with the bottom plate such that the first electrode in one of the plurality of top plate wells is in contact with the at least one medium contained in one of the plurality of bottom plate wells; and
whereby a sustainable electrical characteristic generated when a first electrode lead wire and a corresponding second electrode lead wire are electrically connected by an external circuit indicates that an electrogenic biofilm is present.

16. The sensor according to claim 9, wherein at least one of the first electrode and the second electrode further comprise a porous coating that prevents attachment of a biofilm and allows diffusion of ionic species.

17. The sensor according to claim 10, wherein the first electrode comprises tantalum/tantalum pentoxide, the second electrode is partially coated by the biofilm, and the sensor does not include a proton exchange membrane.

18. The sensor according to claim 9, wherein at least one of the first electrode and the second electrode further comprise a dual plate electrode, the dual plate electrode having a first metal plate in direct contact with a second inert plate, and the first metal plate including a porous coating to cover any surface of the first metal plate that is not in direct contact with the second inert plate to prevent attachment of a biofilm.

19. A drop-in biofilm sensor module for placement within a structure containing at least one medium suspected of containing microbes capable of forming a corrosive biofilm, the sensor module comprising:
a chamber at least partially enclosing at least one first electrode in an interior of the chamber, the chamber configured such that the at least one medium enters the interior and contacts the at least one first electrode to allow a biofilm to form on at least a portion of the at least one first electrode;
wherein the at least one first electrode having the biofilm formed on at least a portion thereof is subsequently electrically connected to at least one second electrode by an external circuit; and
whereby a sustainable electrical characteristic generated when the at least one first electrode and the at least one second electrode are electrically connected and exposed to the at least one medium indicates that the biofilm is electrogenic.
